(19) United States
(12) Patent Application Publication
(10) Pub. No.: US 2006/0110621 A1
(43) Pub. Date: May 25, 2006

(54) Corrosion resistant coatings and method of producing

(76) Inventors: George H Brilmyer, Cortland, OH (US); Robert G Miller, Austintown, OH (US); Stella C Kotsatos, Warren, OH (US); James F Green, Warren, OH (US)

Correspondence Address: HAHN LOESER & PARKS, LLP, One GOJO Plaza, Suite 300, AKRON, OH, 44311-1076, US

(21) Appl. No.: 10/519,965

(22) PCT Filed: Jul. 1, 2003
(86) PCT No.: PCT/US03/20770

§ 371 Date: Dec. 27, 2005

Related U.S. Application Data
(60) Provisional application No. 60/392,878, filed on Jul. 1, 2002.

(51) Int. Cl. B32B 9/00; B32B 19/00

(52) U.S. Cl. 428/689; 427/228; 428/408

(57) ABSTRACT

Metallic coatings and alloys are deposited by thermally reducing inorganic or organic salts containing one or more metals and/or other cationic species in a reducing atmosphere at elevated temperatures. This environmentally-friendly deposition process enables a wide variety of metal and metal alloy compositions to be formed, including metallic or alloy deposits that could not otherwise be electroplated out of water-based solutions. This thermal reduction process and the deposits produced thereof can be applied onto flat strips, sheets, or plates for subsequent fabrication into components and devices and or onto formed parts as intermediate or final surface treatments, particularly components such as battery cans.

The present invention relates to a method of depositing atoms of a first metal onto a surface of a substrate of a second metal. In the method, a salt of the first metal is dissolved into a suitable solvent to form a solution, the solution is coated onto the substrate and the coated substrate is heated in a reducing atmosphere. A particular application is found in depositing nickel and/or cobalt into a stainless steel for use as a corrosion-resistant can for an alkaline battery.

### BACKGROUND OF THE ART

Plating is a well-known means for depositing metallic and alloy coatings and has been practiced for many years. Plating is a process that allows the surface properties of a substrate to be altered by applying a metallic or alloy deposit onto the surface of that substrate. In general, plating is accomplished by utilizing a liquid or molten salt media containing the desired metal species to be deposited. The metal species in the liquid or molten salt media is generally present in the form of metal ions. The metal species is then reduced electrochemically from its ionic state into a solid state. This newly-formed solid, in turn, becomes the deposit on the substrate.

In the case of electroplating, metal species is reduced electrochemically by an electrical current. The substrate to be electroplated is submerged in or is made to come into contact with an electrolyte or media containing the desired metal ions to be plated. An electric circuit is created by connecting a power supply in series with an anodic electrode, the electrolyte or media containing the desired metal ions to be plated, and a cathodic electrode. The cathodic electrode serves as the substrate to be plated upon. The potential difference that is created between the two electrodes in the presence of the metal ions in the electrolyte results in an electrochemical reduction of the metal ions and the deposition of the solid metal species onto the substrate, i.e. the cathode.

In the case of “electroless” plating, chemical reducing agents electrochemically reduce the metal species. These reducing agents are chemicals that, when in the presence of metal ion species, become oxidized while simultaneously driving an electrochemical reduction reaction such that the metal species in the liquid media is plated out onto the substrate.

While these are widely practiced processes, they both suffer from significant shortfalls.

Electroplating requires the use of sophisticated and expensive power supplies for converting and controlling a direct current electrical flow between the anode and cathode. In addition, large volumes of liquid media are generally necessary for accomplishing the electroplating process. Furthermore, an extensive range of support equipment is needed for adequately controlling the process. Even then, the thickness distribution of electrodeposits may be less than uniform due irregularities in the relative size and shape of the plating electrodes and corresponding variations in the effective applied current densities.

Electroless plating requires the continuous addition of chemical reducing agents in order to allow the electrochemical reduction, i.e. the plating process, to proceed. These chemical reducing agents are not only expensive but also react to form byproducts that subsequently build up to deleterious levels in the plating media.

Both of these plating processes are expensive and oftentimes represent a total of 40% or greater of the overall total costs for producing a particular plated material. In addition, depending upon the process conditions, the quality and the performance of the deposit produced by these means may suffer.

As a result, an alternative production means has long been needed that is both more economical and more uniform for depositing metals and alloys onto the surface of substrates.

Plating is by far the most widely practiced means for applying a surface deposit of a metal or alloy onto a substrate. Other technologies also exist for applying a surface deposit including such technologies as hot-dip plating, thermal spraying, mechanical plating, physical vapor deposition, chemical deposition, etc. All of these technologies, although suitable for some applications, suffer from a lack of uniform controllability and/or high costs.

U.S. Pat. No. 4,097,351 (Jun. 27, 1978) describes a non-electrochemical process whereby nickel and/or chromium oxides are colloidally suspended in an aqueous bath containing polyacrylic acid and an organic amine and are electrophoretically attached to a substrate. The coated substrate is then exposed to elevated temperatures in a hydrogen-reducing atmosphere for extended periods of time to reduce the nickel and/or chromium oxides into metallic form which is, in parallel, diffused in with the substrate material. This process suffers from a number of drawbacks. Because the initial application process is electrophoretic in nature, the process is prone to many of the same negative aspects that are associated with electroplating. In addition, the process utilizes expensive organic components and polymers. It also makes use of relatively large metal oxide particles (in the range of about 1 to 5 microns), which adversely impacts the ability to apply thin uniform deposits. The process requires numerous coating and treatment steps and the process employs long reaction times (6-60 hours) to accomplish the reduction process. In short, the process is much too time-consuming and too expensive.

A conventional alkaline cell uses a zinc gel anode and a MnO₂ cathode. The highly oxidizing cathode material is in direct contact with an interior of the can in which the cell is formed, so the can, or at least an interior surface, must be corrosion-resistant. Nickel-plated low carbon steel has been a preferred substrate for many years, but cost pressures from the cell manufacturers have caused the suppliers to look at alternatives. This is especially true when a review of the costs reveals that the electroplating operation is one of the most costly steps.

It is an object of the present invention to provide high-performing low-cost metal and alloy deposits and to provide a simple and practical means for producing such deposits. It is also a desirable object to provide a corrosion-resistant, and particularly alkali-resistant, material that is suitable for being formed into a can for containing an alkali cell.

### SUMMARY OF THE INVENTION

This and other objects of the invention are achieved by a thermal salt reduction process that renders at least one surface of a metal substrate, especially a stainless steel sheet, suitably alkali-resistant for use as a container for an alkaline battery.

The method for depositing atoms of at least one first metal onto at least one surface of a substrate of a second metal comprising four steps. The first step is to clean the surface for receiving the deposition. The second step is to dissolve a salt of each at least one first metal into a solvent to provide a solution containing dissolved ions of each at least one first metal. The third step is to provide a coated surface on the substrate by the steps of applying a layer of the metal-ion-containing solution to the surface and removing the solvent. The fourth step is thermally reducing the metal ions of each at least one first metal by heating the substrate in a reducing atmosphere at a temperature greater than ambient for a time sufficient to deposit the atoms of each at least one first metal onto the coated surface of the substrate and cooling the substrate before removing the substrate from the reducing atmosphere.

In some embodiments, the reducing atmosphere comprises 5% hydrogen and 95% nitrogen.

In some embodiments, the thermal reduction step is conducted at a temperature of at least 400° C., and particularly, at a temperature below the melting point of the second metal.

In some embodiments, the solvent is water, but in other embodiments, the solvent is an organic liquid, especially methanol. The solvent selection is based upon solubility of the salt of the first metal in the solvent.

The preferred salts for the present invention have anions that are selected from the group comprising oxygen, hydrogen, nitrogen, carbon and combinations thereof, such as hydroxides, oxides, oxalates, carbonates, bicarbonates, citrates, cyanides, formats, acetates, nitrates and nitrites.

In some embodiments, the second metal substrate is formed into a useful article before the coating step and the thermal reduction step accomplishes a heat-treating step that is otherwise required for the useful article. In one such instance, the invention may comprise a battery can produced by this method, where the second metal is a stainless steel and the at least one first metal is selected from the group consisting of nickel, cobalt and combinations thereof.

In a particular embodiment, the second metal is a stainless steel and the first metal is nickel, cobalt or a combinations thereof.

In other embodiments, the first metal is selected from a group consisting of chromium, molybdenum, tungsten, vanadium, niobium, tantalum, titanium, zirconium, boron, aluminum, gallium, silicon, germanium and phosphorus.

The invention may be incorporated into a steel strip produced by the method described above, or in a battery can produced from the steel strip.

The invention may also comprise an alkaline cell comprising a battery can made according to the method of the invention.

### DETAILED DESCRIPTION OF A PREFERRED EMBODIMENT

The present invention entails several steps. The first of the steps is to dissolve one or more readily-available inexpensive metal-containing salts into a suitable liquid solvent. The metal-containing salts should obviously be composed of the metal or alloy system that is desired to be deposited. These metal salts may contain either inorganic anion species or, as appropriate, organic-based anion species. Similarly, the liquid solvent can be either aqueous-based or organic-based as appropriate.

A second of the steps is to properly prepare at least one surface of a metal to act as a substrate for the deposited metals.

The metal-containing solution is then applied uniformly onto the surface of the desired substrate to be coated. The solution can be applied in any number of means including dipping, spraying, roll-coating, electrostatic coating, etc. The subsequently-coated substrate is introduced into a heated furnace or oven where the thermal reduction process is allowed to occur. As desired, the substrate can be dried prior to introduction into the thermal reduction furnace to remove some or all of the residual liquid solvent associated with the applied salt solution.

In the furnace, a protective atmosphere containing a reducing gas, preferably hydrogen is introduced. Reducing atmospheres in furnaces typically contain an inert gas such as nitrogen combined with various percentages of hydrogen. The furnace gas mixtures are selected to optimize the reduction capacity of the gas and the safety aspects of the process. The coated substrates are exposed to elevated temperatures for a period of time in order to allow the thermal reduction of the applied coating to proceed. After the prescribed heat-treating cycle, the substrate is removed from the furnace. The metal-containing solution that was previously on the substrate has now been converted into a metallic or alloy deposit depending upon the time and the temperatures at which the thermal reduction process was conducted. Any residual solvent from the solution has been evaporated and/or decomposed.

When hydrogen (H₂) is employed as the reducing gas in conjunction with this invention, the effective chemical reaction for this process can be simplified into the following equation:
xM⁺ⁿ+yH₂→xM+2.yH⁺

where M is any metal or element existing as a cation in the applied salt.

This invention is applicable to any metal or alloy whose ions are soluble in aqueous or non-aqueous solutions. Ideally, the metal salts used for dissolution should be ones that are readily-available, are readily-soluble, and are inexpensive in terms of the costs per the effective molar metal content. In order to minimize the influence of corrosion on processing equipment, the metal salts used for dissolution should ideally be ones possessing only oxygen, hydrogen, nitrogen, and/or carbon in the anionic portion of the salt. In other words, soluble salts, such as hydroxides, oxides, oxalates, carbonates, bicarbonates, citrates, cyanides, formates, acetates, nitrates, nitrites, etc., are the preferred salt species. However, other less preferred salt species can be used such as sulfates, chlorides, phosphates, borates, and others, which potentially may or may not form corrosive byproducts during the thermal reduction process.

Similarly, this invention is applicable to any substrate whose melting temperature is less than the temperature at which the thermal reduction process is conducted. In particular, this invention is ideally suited to any substrate that requires a heat treatment step somewhere within its processing route. In other words, for such substrates, this invention has the added benefit of potentially being able to combine the deposition process in with the heat-treating process, in such processes that would normally require a heat-treating process. Thus, this invention potentially eliminates at least one process step in such a manufacturing sequence.

In general, the thermal reduction process is a fast process that can be accomplished in the manner of only a few seconds up to several minutes, depending upon the metal salts being employed and the degree of alloying desired. Typically, the thermal reduction process takes place at temperatures greater than 400° C. However, the particular metal salt being utilized and the degree of alloying desired dictate the actual temperatures that are required. For most salts, the thermal reduction process is incomplete at temperatures less than 400° C. High temperatures permit the thermal reduction process to be driven faster. In addition, higher temperatures enable greater degrees of diffusion and alloying to take place.

Because the process is (1) fast, (2) environmentally-friendly, (3) utilizes readily-available salts, and (4) typically combines multiple processing steps into a single operation, this thermal reduction invention is a desirable low-cost means for producing a wide range of high-performing deposits.

Nickel and/or Cobalt Deposits for Battery can Applications

Battery cans and end caps for alkaline primary and rechargeable batteries have for many years been produced out of low carbon steel that is electroplated with nickel and/or cobalt. Typically, because strip plating is less expensive than parts plating, the nickel and/or cobalt are plated onto steel strip. The battery cans and end caps are subsequently then formed out of this pre-plated strip. Nickel and cobalt are the deposits of choice because of their superior performance in alkaline environments.

Nonetheless, the nickel and cobalt plating processes are expensive processes, even when utilizing continuous high-speed steel strip plating lines. Continuous strip electroplating, although benefiting from the economy of scale, still suffers from the general drawbacks associated with electroplating that have been discussed earlier.

The utilization of this present invention as a replacement of the currently-used electroplating process is extremely beneficial. This present invention not only provides for a cost-effective alternative to electroplating but also eliminates the need for a separate annealing heat-treatment step that would otherwise be required in the currently-used electroplating process.

In addition, the deposit produced using the present invention is superior in performance to nickel-plated or cobalt-plated steel as measured in the cathode cup test described below. The test results are further enumerated in the examples that follow.

Furthermore, the use of the present invention for battery applications is not limited to the deposition of nickel and/or cobalt onto continuous strip. The invention is also perfectly applicable to the post-coating of pre-formed cans. In other words, pre-formed battery cans made out of steel or nickel-plated steel are able to be readily coated with a subsequently-applied nickel and/or cobalt deposit. The deposit produced using the present invention can be applied to one or both sides of the can, although the greatest performance improvement is observed when the deposit is applied to the inside of the can.

When this invention is applied to the coating of cans, the metal-containing solution is simply sprayed onto the surface of the can, preferably the inside surface of the can. The can is then subjected to a heat treatment at an elevated temperature in the presence of a reducing atmosphere, preferably containing hydrogen. The cans are then suitable to be filled and processed into individual cells. The heat treatment process not only acts to reduce the metal salts into metallic species but also acts to temper the steel substrate that has been cold-worked into a work-hardened condition during the canmaking operation.

The invention also possesses further benefits for coated battery cans in that, as a supplement to the nickel/cobalt-containing solution, carbon and/or graphite can be added to the metal-containing solution so that, after heat treatment, the inside surface of the can possesses not only a nickel/cobalt metallic surface but also a surface containing carbon and/or graphite. The presence of carbon and or graphite further acts to improve the performance of alkaline cells.

The present invention is best illustrated by examples of the process.

### EXAMPLE 1

Full hard cold rolled steel sample coupons (5″×8″×0.010″) were cleaned by conventional bipolar alkali electrocleaning. The coupons were then rinsed in deionized water, pickled in a 3% hydrochloric acid solution, rinsed again and dried.

The dried coupons were uniformly sprayed with an aqueous solution having a nickel ion [Ni⁺⁺] concentration of 50 g/l and a cobalt ion [Co⁺⁺] concentration of 50 g/l, using sulfate salts of these metals After spraying, the coupons were slowly dried in an atmospheric oven at 120° C. The coated coupons were then welded onto a carrier strip and fed into a strand-annealing furnace in a reducing atmosphere comprising 5% hydrogen in a balance of nitrogen. In the furnace, the coupons were exposed to a temperature of 925° C. for 6 minutes. The coupons were then cooled to below 100 F before exiting the furnace and its reducing atmosphere.

The coupons were tested in a cathode cup test (CCT) that simulates the environment of a cathode in an alkaline cell. They were also given a glow discharge optical emission spectroscopy (GDOES) depth profiling test. The tests and the results thereof are described below.

### EXAMPLE 2

Coupons of the same size and composition as in Example 1 were prepared in the same manner as in Example 1.

Instead of using an aqueous solution as in Example 1, an organic solution of anhydrous methanol containing nickel acetate, cobalt acetate, and ammonium hydroxide was prepared to provide the same nickel metal concentration [Ni⁺⁺] of 50 g/l and cobalt metal concentration [Co⁺⁺] of 50 g/l as used in Example 1. The previously cleaned and dried sample coupons were then uniformly roll-coated with the organic salt solution. The coated sample coupons were allowed to dry in an atmospheric oven at 120° C. to evaporate the majority of the methanol solvent. The coated sample coupons were then treated in the same manner as in Example 1 in the strand-annealing furnace filled with a reducing atmosphere containing 5% hydrogen and 95% nitrogen where they were exposed to a temperature of 925° C. for 6 minutes and cooled to a temperature below 40° C. before exiting the furnace.

The coupons were tested, using the same tests as in Example 1. The tests and the results thereof are described below.

### COMPARATIVE EXAMPLE 3

As a point of comparison, unplated annealed cold-rolled steel sample coupons were subjected to the same cathode cup test and GDOES depth profiling as in Example 1. The cathode cup test showed an initial resistance of 0.42 ohms, but the aged resistance increased to 20.33 ohms, and was still increasing at the end of the 28-day test.

The surface composition was found to be 100% Fe, 0% Ni, 0% Co, <0.1% C, and <0.1% S, exemplary of the unplated nature of the coupons. Unplated annealed cold-rolled steel of these characteristics would not be considered acceptable as an alkaline battery can

### COMPARATIVE EXAMPLE 4

As a further point of comparison, annealed nickel-plated steel, in sample coupons, as typically used for alkaline batteries, was subjected to the same cathode cup test and GDOES depth profiling as in Example 1. The cathode cup test showed an initial resistance of 0.38 ohms and an aged resistance of 7.55 ohms. The surface composition was found to be 2% Fe, 98% Ni, 0% Co, <0.1% C, and <0.1% S.

### COMPARATIVE EXAMPLE 5

As a yet further point of comparison, sample coupons of an annealed nickel-cobalt plated steel typically used for alkaline batteries were subjected to the same cathode cup test and GDOES depth profiling as in Example 1. The coupons showed an initial resistance of 0.62 ohms and an aged resistance of 3.63 ohms. Even though the initial resistance was somewhat higher than that of the unplated steel, the aged resistance at 28 days was stable at a much lower resistance. The surface composition was found to be 8% Fe, 42% Ni, 50% Co, <0.1% C, and <0.1% S.

Test Results

Coating efficacy was tested using a cathode cup test in which two 0.75″ disks, formed from a coupon of the material to be tested, were mounted in facing opposition with a quantity of cathode mix between them to form a sandwich of the disks and the cathode mix. These sandwiches were then placed in an oven and aged at 71° C. They were removed periodically and the electrical resistance was measured. The aged resistances reported below are all measured at 28 days. This cathode cup test simulates the effect of aging on the can-to-cathode interface in alkaline batteries. The performance of alkaline batteries has been found to improve when the resistance as measured in the cathode cup test (CCT) is reduced.

| | Example | Example | Compar. | Compar. | Compar. |
|---|---|---|---|---|---|
| | 1 | 2 | Example 3 | Example 4 | Example 5 |
| % Fe at | 90 | 42 | 100 | 2 | 8 |
| Surface | | | | | |
| % Ni at | 4.3 | 33 | — | 98 | 42 |
| Surface | | | | | |
| % Co at | 4.0 | 28 | — | — | 50 |
| Surface | | | | | |
| Initial | 0.40 | 0.20 | 0.42 | 0.38 | 0.62 |
| CCT (ohms) | | | | | |
| Final | 4.74 | 1.43 | 20.33 | 7.55 | 3.63 |
| CCT (ohms) | | | | | |

The test results obtained using the present invention were comparable to or better than the results of the materials routinely being used for alkaline batteries. In fact, the results obtained when producing a thermally-reduced nickel-cobalt alloy deposit under the conditions of Example 2 generated CCT resistance values that were significantly lower than the CCT resistance values of nickel-cobalt alloy produced using electroplating.

Other Uses

The uses of this invention are not limited to just nickel and/or cobalt deposits. Similarly, this invention is not limited to applications involving alkaline batteries.

This invention, which entails producing deposits by thermally reducing metal salt solutions that have been applied onto a substrate, is applicable to any metal or combination of metals that exist in salt form as a cationic species and than can be subsequently reduced into its non-ionized or metallic state.

This invention that includes both the process and the deposits produced thereof is especially suitable for metals and elements or alloys of these metals and elements that are otherwise difficult to electroplate out of an aqueous solution. Some of these difficult to plate metals or elements include chromium, molybdenum, tungsten, vanadium, niobium, tantalum, titanium, zirconium, boron, aluminum, gallium, silicon, germanium, and phosphorous.

This invention is also especially suitable for depositing precisely-controlled compositions of metals alloys or elemental alloys. Because the thermally-reduced deposits are produced using salt solutions having known compositions, the final composition of the deposit can be readily controlled by carefully weighing and preparing the amount of constituent salts that are added to the salt solution for each of the metallic or elemental species. Thus, the control of the alloy composition is primarily a function of the accuracy of the preparation methodology for weighing up the salt solution. By comparison, the control of the alloy composition in electroplated deposits is a function of a wide variety of difficult to control variables, including bath concentrations, applied current densities, bath temperatures, solution agitation, and other factors. As a result, the composition of thermally-reduced alloy deposits is much easier to control and maintain.

This invention has the further advantage of permitting the ready incorporation of otherwise insoluble components into the deposit In other words, otherwise insoluble species, such as carbon, graphite, carbides, silicon oxide, molybdenum disulfide, titanium disulfide, tantalum disulfide etc., can be suspended in the salt solution and, when the salt solution is applied onto the surface of the substrate, the insoluble species will be included in the layer of salts that is formed on the substrate. When this surface layer is subsequently thermally reduced, these insoluble species will become incorporated into the thermally-reduced deposit. Thus, this invention provides a relative easy and straightforward means for generating dispersion deposits.

Obviously, experts skilled in the art of electroplating and familiar with metal systems that can and can not be electroplated will also readily be able to see a wide range of possible opportunities. Accordingly, this invention hereby discloses the fundamental principles associated with the thermal salt reduction process and discusses but a small number of specific products and applications that make use of this process. Many other extensions of this process are obvious and are hereby also disclosed with this invention.

1. A method for depositing atoms of a least one first metal onto at least one surface of a substrate of a second metal, comprising the steps of:
cleaning said at least one surface for receiving the deposition;
dissolving a salt of each at least one first metal into a solvent to provide a solution containing dissolved ions of each at least one first metal;
providing a coated surface on the substrate by the steps of applying a layer of the metal-ion-containing solution to the surface and removing the solvent; and
thermally reducing the metal ions of each at least one first metal by heating the substrate in reducing atmosphere at a temperature greater than ambient for a time sufficient to deposit the atoms of each at least one first metal onto the coated surface of the substrate and cooling the substrate before removing the substrate from the reducing atmosphere.

2. (canceled)

3. The method of claim 1, wherein the thermal reduction step is conducted at a temperature of at least 400° C.

4. The method of claim 1, wherein the thermal reduction step is conducted at a temperature below the melting point of a second metal.

5. The method of claim 1, wherein the solvent is selected from the group consisting of water and organic liquids.

6. (canceled)

7. (canceled)

8. (canceled)

9. (canceled)

10. The method of claim 1, wherein the salt has anions that are selected from the group comprising oxygen, hydrogen, nitrogen, carbon and combinations thereof.

11. The method of claim 10, wherein the salt of each at least one first metal is selected from the group consisting of hydroxides, oxides, oxalates, carbonates, bicarbonates, citrates, cyanides, formates, acetates, nitrates and nitrites.

12. The method of claim 1, wherein the second metal substrate is formed into a useful article before the coating step and the thermal reduction step accomplishes a heat-treating step that is otherwise required for the useful article.

13. The method of claim 1, wherein the second metal is a steel.

14. The method of claim 13, wherein the at least one first metal is selected from a group consisting of nickel, cobalt and combinations thereof.

15. The method of claim 1, wherein the at least one first metal is selected from a group consisting of chromium, molybdenum, tungsten, vanadium, niobium, tantalum, titanium, zirconium, boron, aluminum, gallium, silicon, germanium and phosphorus.

16. A metal-coated steel strip which displays a measured resistance of less than about 1.5 ohms after aging in an oven at 71° C. for 28 days.

17. A battery can produced from the steel strip of claim 16.

18. A battery can produced by the method of claim 12, wherein the at least one first metal is selected from the group consisting of nickel, cobalt and combinations thereof, and wherein the battery can displays a measured resistance of less than about 1.5 ohms after aging in an oven at 71° C. for 28 days.

19. An alkaline cell comprising a battery can of claim 17.

20. The method of claim 1, wherein the solution containing dissolved ions of each at least one first metal additionally comprises carbon.

21. The method of claim 20, wherein the carbon comprises graphite.

22. The method of claim 14, wherein the method provides an alloy of steel and a metal selected from the group consisting of nickel, cobalt, and combinations thereof.

23. The method of claim 22, wherein the second metal is low carbon steel.

24. The method of claim 22, additionally comprising fashioning the alloy into a battery can.

25. The method of claim 1, wherein the second metal is a pre-formed battery can.

26. The method of claim 25, additionally comprising forming an alkaline cell from the battery can.

27. A metal-coated steel strip according to claim 16, wherein the metal coating further comprises carbon.
